(19) United States
(12) Patent Application Publication
(10) Pub. No.: US 2009/0157841 A1
(43) Pub. Date: Jun. 18, 2009

(54) ENCAPSULATION OF ONLINE STORAGE PROVIDERS

(75) Inventors: Richard Shailer Turner, JR., Woodinville, WA (US); Pradyumna Siddhartha, Seattle, WA (US); Ignatius Setiadi, Redmond, WA (US); Eric Jonathan Wright, Seattle, WA (US)

Correspondence Address: SENNIGER POWERS LLP (MSFT), 100 NORTH BROADWAY, 17TH FLOOR, ST. LOUIS, MO, 63102, US

(73) Assignee: MICROSOFT CORPORATION, Redmond, WA (US)

(21) Appl. No.: 11/957,134

(22) Filed: Dec. 14, 2007

(51) Int. Cl. G06F 15/16

(52) U.S. Cl. 709/217

(57) ABSTRACT

A media publisher manager generates a plug-in for each of a plurality of providers. Each provider hosts a web space including a media object and implements a plurality of services related to the media object. Executing the plug-in causes at least one of the plurality of services related to the media object to be performed on at least one of plurality of providers. The media publisher manager request is receives from a client. The request includes a function related to a media object and a moniker of the media object. The moniker is generated from a media object identifier and a provider identifier. A plug-in is selected based on the provider identifier of the moniker. Executing the selected plug-in causes a service related to the media object to be preformed on the provider, said service related to the requested function.

### BACKGROUND

A great number of providers provide various services related to media objects for social networking. For example, there are services that allow a user to post and share photos and allow a user to post and share video. However, each provider implements a set of constructs designed around a storage back end and each storage back end has a different set of constructs that enable a developer to interact with the storage. For example, one service may expose a specific SOAP (Simple Object Access Protocol) interface for interacting with the storage. Other providers may use other technologies such as RSS (Really Simple Syndication), HTTP (HyperText Transfer Protocol) variants, and telnet.

### SUMMARY

Embodiments of the invention overcome one or more vulnerabilities associated with the use of multiple constructs to manage media objects associated with a plurality of providers. Aspects of the invention include generating a plug-in for each of the plurality of providers. Each provider hosts a web space including a media object and implements a plurality of services related to the media object. Executing the plug-in causes at least one of the plurality of services related to the media object to be performed on at least one of plurality of providers.

In another embodiment, a request is received from a client. The request includes a function related to a media object and a moniker of the media object. The moniker is generated from a media object identifier and a provider identifier. A plug-in is selected based on the provider identifier of the moniker. Executing the selected plug-in causes a service related to the media object to be performed on the provider.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Other features will be in part apparent and in part pointed out hereinafter.

### BRIEF DESCRIPTION OF THE DRAWINGS

FIG. 1 is a block diagram illustrating one example of a suitable computing system environment in which the invention may be implemented.

FIG. 2 is an exemplary flow diagram illustrating a method for publishing media objects to a provider.

FIG. 3 is an exemplary flow diagram illustrating a method for publishing media objects to a provider.

FIG. 4 is an exemplary flow diagram illustrating a method for publishing media objects to a provider.

Corresponding reference characters indicate corresponding parts throughout the drawings.

### DETAILED DESCRIPTION

Referring now to the drawings, aspects of the invention implement a media publisher manager which publishes media objects to a plurality of providers. Advantageously, as new providers become available, the client does not need to learn the constructs particular to that provider. Instead, a plug-in is created for the provider and the client's request can be executed without the client knowing or accessing the underlying constructs of the provider.

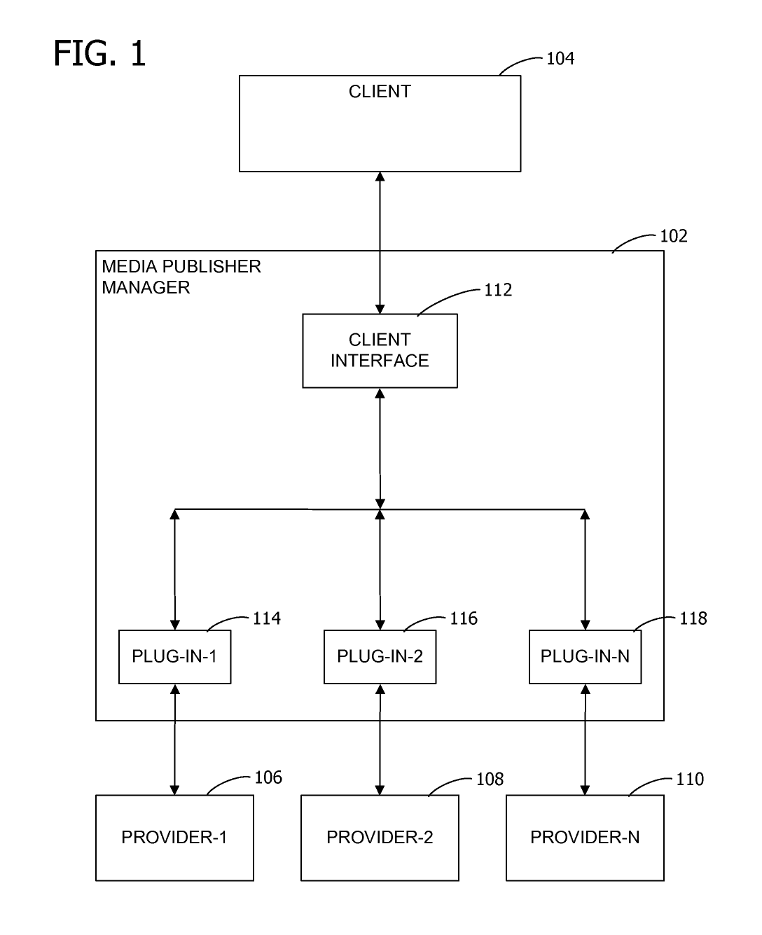

FIG. 1 is a block diagram illustrating one example of a suitable computing system environment in which the invention may be implemented. The system includes a media publisher manager 102 for publishing a media object from a client 104 to one or more providers (e.g. provider-1 106, provider-2 108, provider-N 110). For example, the media object may include one or more of the following: a digital photograph, a digital video, a digital sound recording, and a document. Alternatively, the media objects are related to social networking. Social networking is an online social community for people who share interests and activities, or who are interested in exploring the interests and activities of others. Most social networks are primarily web based and provide a collection of various ways for users to interact, such as chat, messaging, email, video, voice chat, file sharing, blogging, discussion groups, and so on.

The media publisher manager 102 includes a client interface 112 and one or more plug-ins (e.g. plug-in-1 114, plug-in-2 116, plug-in-N 118) corresponding to the providers (e.g. provider-1 106, provider-2 108, provider-N 110). The client interface 112 receives a request including a function from the client 104. In an embodiment, the function includes one or more of the following: publish a media object to a provider; remove a media object from a provider, download a media object from a provider, subscribe to a media object of a provider, list the media objects published, list the providers that have invited the client 104 to subscribe, and list the media objects subscribed.

For example, suppose user wishes to upload a photo (e.g., media object) located on the hard drive of the client 104 to a web photo sharing service (e.g., provider-1 106). The user accesses an application executing on the client 104, and this application sends a request to the client interface 112 of the media publisher manager 102. The client interface 112 selects the appropriate provider (e.g., provider-1 106) and executes the corresponding plug-in (e.g., plug-in-1 114). The execution of the plug-in causes the provider to upload the photo from the client's hard drive. And in response to the uploading, the provider sends a moniker associated with the uploaded photo to the media publisher manager 102. The media publisher manager 102 sends a moniker to the client 104. The moniker includes a provider identifier that identifies the provider that uploaded the user's photo and an identifier that identifies the user's uploaded photo on the provider (e.g., provider-1 106). The identifier included in the moniker is an opaque blob of data that is only meaningful to the provider who created the moniker. The identifier includes the information needed by the provider to identify the uploaded photo on the web photo sharing service. The client 104 references the uploaded photo via the moniker.

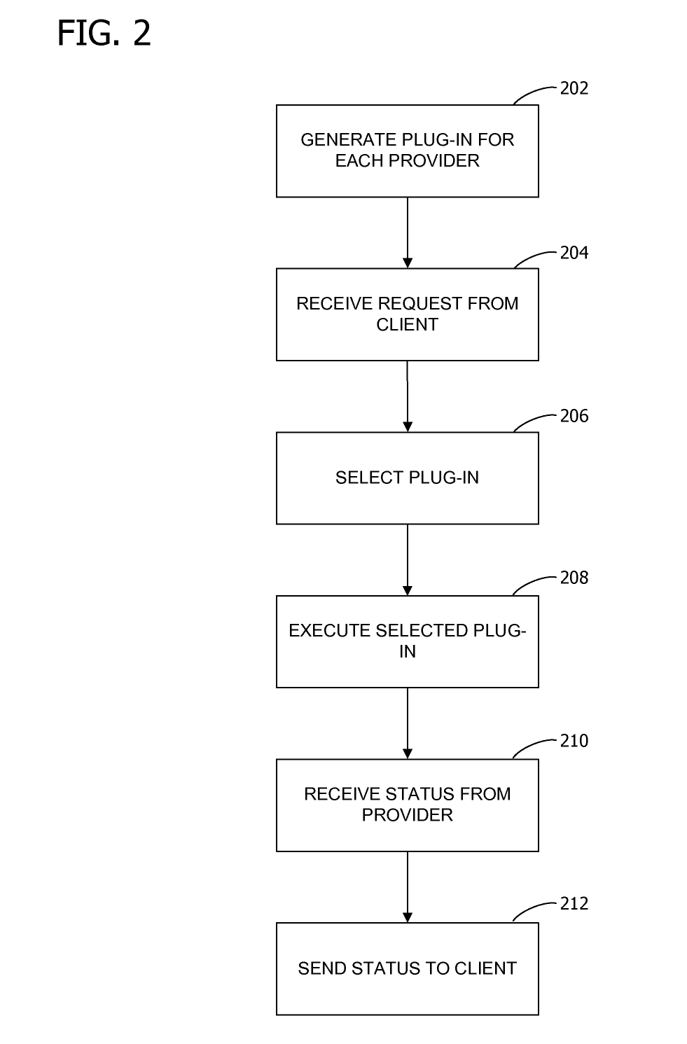

FIG. 2 is an exemplary flow diagram illustrating a method for publishing media objects to a provider (e.g. provider-1 106, provider-2 108, provider-N 110). At 202, the media publisher manager 102 identifies a plurality of plug-ins (e.g. plug-in-1 114, plug-in-2 116, plug-in-N 118), one corresponding to each of a plurality of the providers (e.g. provider-1 106, provider-2 108, provider-N 110). Each of the providers hosts a web space including a media object and each of the providers implements a plurality of services related to the media object.

In an embodiment, the media object may include one or more of the following: a digital photograph, a digital video, a digital sound recording, and a document. Executing the corresponding plug-in for a particular provider (e.g. provider-1 106, provider-2 108, provider-N 110) causes at least one of the plurality of services of the particular provider related to the media object to be performed on the particular provider.

At 204, the media publisher manager 102 receives a request from a client 104. The request includes a function related to a media object. In an embodiment, the function includes one or more of the following: publish a media object to a provider; remove a media object from a provider, download a media object from a provider, subscribe to a media object of a provider, list the media objects published, list the providers that have invited the client to subscribe, and list the media objects subscribed.

At 206, the media publisher manager 102 selects one of the plurality of plug-ins (e.g. plug-in-1 114, plug-in-2 116, plug-in-N 118) to execute based on the included function. In an embodiment, the plug-in utilizes one or more of the following protocols to communicate with provider: SOAP (Simple Object Access Protocol), RSS (Really Simple Syndication), HTTP (HyperText Transfer Protocol), and telnet.

At 208, the media publisher manager 102 executes the selected plug-in (e.g. plug-in-1 114, plug-in-2 116, plug-in-N 118). Executing the selected plug-in causes a service related to the media object to be performed on the provider. The service is related to the requested function.

At 210, the media publisher manager 102 receives a status indicating the success of the performed service from the provider. In an embodiment, the status is received asynchronously from the provider. And, at 212, the media publisher manager 102 sends the status indicating the success of the request to the client 104.

In an embodiment, the requested function includes the uploading of the media object to the provider. In this embodiment, the media publisher manager 102 selects one of the plurality of plug-ins to execute to upload the media object. The media publisher manager 102 executes the selected plug-in to cause the provider to upload the media object from the client 104. The media publisher manager 102 receives a moniker for the uploaded media object from the provider in response to the execution of the plug-in. The moniker is generated by the provider in response to the uploading of the media object. The provider generates a moniker from the media object identifier and a provider identifier. The moniker includes the uploaded media object identifier and the provider identifier. The provider identifier is associated with the provider which uploaded the media object and the media object identifier includes the information needed by the provider to identify the uploaded media object. In an embodiment, the media object identifier is an opaque blob of data that is only meaningful to the provider that uploaded the media object.

The media publisher manager 102 sends the moniker to the client 104. The client 104 references the uploaded media object via the moniker. For example, the client 104 may decide to no longer share the uploaded photo on the web photo sharing service. In this case, the client 104 sends a request to delete the photo, including the moniker of the uploaded photo, to the media publisher manager 102. The media publisher manager 102 will select the plug-in based on the provider identifier of the moniker, and execute the selected plug-in to delete the photo associated with the moniker.

In an embodiment, the moniker is in a serialized form. The media object identifier of the moniker represents a media object in the abstract namespace of the provider. In another embodiment, the data used to represent each of these abstractions will be treated as an opaque blob and the deconstruction of the abstraction is done by an API (application programming interface), not by the client 104. Appendix A is an exemplary design document for such an API.

In another embodiment, the request received at 204 includes a moniker of the media object. The moniker is generated from a media object identifier and a provider identifier. The moniker is provided to a first provider hosting the media object associated with the moniker. The provider identifier is associated with the at least one of the providers.

Next, the media publisher manager 102 determines the provider identifier from the moniker included in the request. In an embodiment, the moniker is in a serialized form. And, at 206, the media publisher manager 102 selects a plug-in to execute from the generated plug-ins based on the provider identifier. At 208, the media publisher manager 102 executes the selected plug-in causing a service related to the media object to be performed on the provider. The service is related to the requested function. And at 210, the media publisher manager 102 receiving a status indicating the success of the performed service from the provider and, at 212, the media publisher manager 102 sends the status to the client 104.

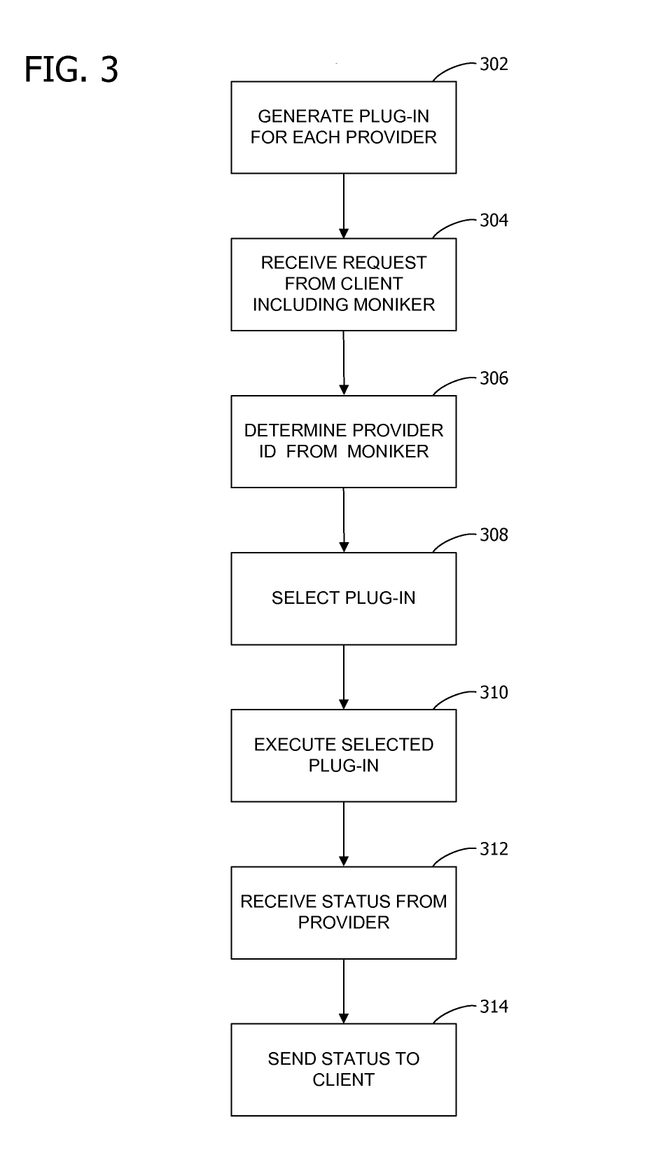

FIG. 3 is an exemplary flow diagram illustrating a method for publishing media objects to a provider (e.g. provider-1 106, provider-2 108, provider-N 110). At 302, the media publisher manager 102 generates a plug-in for each of a plurality of providers, each provider hosting a web space including a media object. Each of the providers implements a plurality of services related to the media object. Executing the plug-in causes at least one of the plurality of services related to the media object to be performed on at least one of plurality of providers.

At 304, the media publisher manager 102 receives a request from a client 104. The request includes a function relating to a media object. The request includes a moniker generated from a media object identifier and a provider identifier. In an embodiment, the moniker is in a serialized form. The media object identifier of the moniker represents a media object in the abstract namespace of the provider. The moniker is provided by a first provider hosting the media object associated with the media identifier and the provider identifier is associated with the at least one of the providers.

At 306, the media publisher manager 102 determines the provider identifier from the moniker included in the request. And, at 308, the media publisher manager 102 selects a plug-in to execute from the generated plug-ins based on the included function and the provider identifier.

At 310, the media publisher manager 102 executes the selected plug-in causing a service related to the media object to be performed on the provider. The service is related to the requested function. And, at 312, the media publisher manager 102 receives a status indicating the success of the performed service from the provider.

At 314, the media publisher manager 102 sends the status indicating the success of the request to the client.

In an embodiment, the requested function includes the downloading of the media object from the provider (e.g. provider-1 106, provider-2 108, provider-N 110). In this embodiment, at 308, the media publisher manager 102 selects a plug-in to execute from the generated plug-ins (e.g. plug-in-1 114, plug-in-2 116, plug-in-N 118) to download the media object from the provider associated with the determined provider identifier. At 310, the media publisher manager 102 executes the selected plug-in causing the provider to download the media object to the client 104.

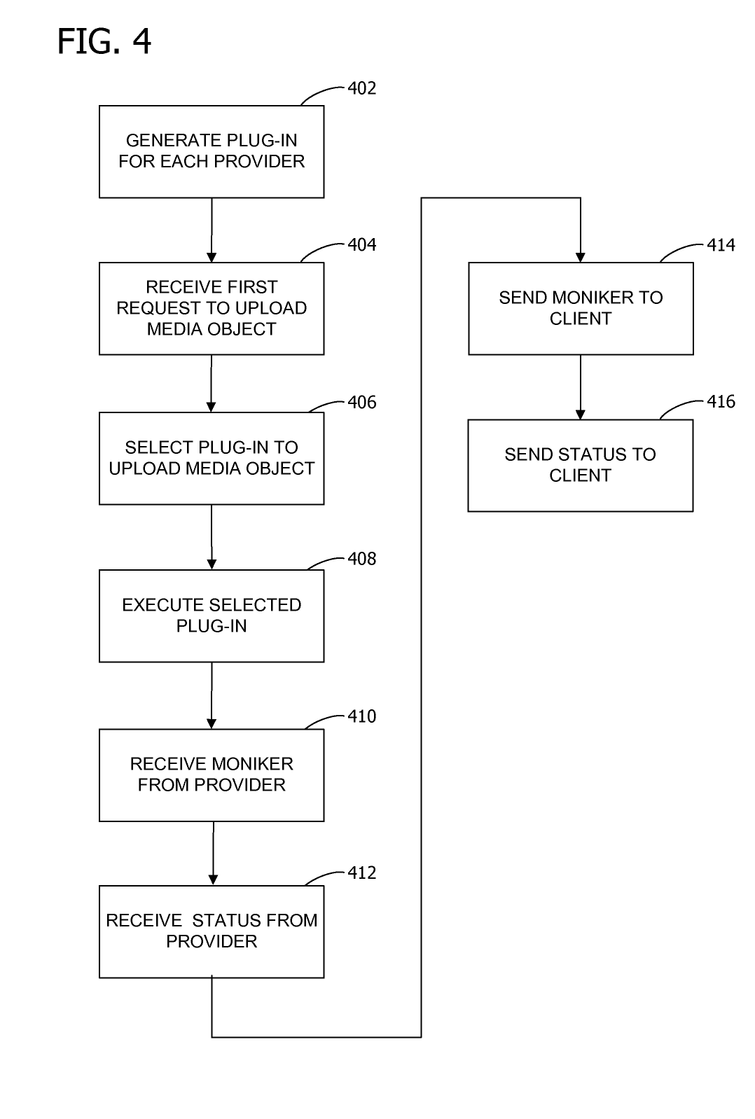

FIG. 4 is an exemplary flow diagram illustrating a method for publishing media objects to a provider. At 402, the media publisher manager 102 generates a plug-in (e.g. plug-in-1 114, plug-in-2 116, plug-in-N 118) for each of a plurality of providers (e.g. provider-1 106, provider-2 108, provider-N 110) hosting a web space including a media object. Each provider implements a plurality of services related to the media object. Executing the plug-in causes at least one of the plurality of services related to the media object to be performed on at least one of plurality of providers. Advantageously, the client 104 is not required to know the underlying constructs required by each provider because these constructs are encapsulated within the plug-ins. Therefore, the client does not need to modify the format of a request each time an underlying construct of a provider is modified.

At 404, the media publisher manager 102 receives a first request including the uploading of a media object from a client 104. Next, at 406, the media publisher manager 102 selects a plug-in to execute from the generated plug-ins to upload the media object.

At 408, the media publisher manager 102 executes the selected plug-in causing the provider to upload the media object from the client 104. And, at 410, the media publisher manager 102 receives a moniker for the uploaded media object from the provider. The moniker is generated by the provider in response to the uploading of the media object. The moniker includes the media object identifier and a provider identifier associated with the at least one of the providers which uploaded the media object. The media object identifier of the moniker represents the uploaded media object in the abstract namespace of the provider.

At 412, the media publisher manager 102 receives a status from the provider indicating the success of the performed service. Next, at 414, the media publisher manager 102 sends the moniker to the client 104. The client 104 references the uploaded media object via the moniker. And, at 416, the media publisher manager 102 sends the status indicating the success of the first request to the client 104.

In an embodiment, the media publisher manager 102 receives a second request including a function related to the media object and the moniker of the media object. In this embodiment, the media publisher manager 102 determines the provider identifier from the moniker included in the second request. And, the media publisher manager 102 selects a plug-in to execute from the generated plug-ins (e.g. plug-in-1 114, plug-in-2 116, plug-in-N 118) based on the included function and the provider identifier. The media publisher manager 102 executes the selected plug-in causing a service related to the media object to be performed on the provider (e.g. provider-1 106, provider-2 108, provider-N 110). The service is related to the requested function and the determined media object identifier. Next, the media publisher manager 102 receives a status indicating the success of the performed service from the provider and sends the status to the client 104.

Referring again to FIG. 1, FIG. 1 shows one example of a general purpose computing device in the form of a computer (e.g. media publisher manager 102). In one embodiment of the invention, a computer such as the computer (e.g. media publisher manager 102) is suitable for use in the other figures illustrated and described herein. Computer (e.g. media publisher manager 102) has one or more processors or processing units and a system memory.

The computer (e.g. media publisher manager 102) typically has at least some form of computer readable media. Computer readable media, which include both volatile and nonvolatile media, removable and non-removable media, may be any available medium that may be accessed by computer. By way of example and not limitation, computer readable media comprise computer storage media and communication media.

Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that may be used to store the desired information and that may be accessed by computer (e.g. media publisher manager 102).

Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of any of the above are also included within the scope of computer readable media.

The computer (e.g. media publisher manager 102) may operate in a networked environment using logical connections to one or more remote computers, such as a remote computer (e.g. provider-1 106, provider-2 108, provider-N 110). The remote computer (e.g. provider-1 106, provider-2 108, provider-N 110) may be a personal computer, a server, a router, a network PC, a peer device or other common network node, and typically includes many or all of the elements described above relative to computer. The logical connections depicted in FIG. 1 include a local area network (LAN) and a wide area network (WAN) 198, but may also include other networks. LAN and/or WAN may be a wired network, a wireless network, a combination thereof, and so on. Such networking environments are commonplace in offices, enterprise-wide computer networks, intranets, and global computer networks (e.g., the Internet).

Generally, the data processors of computer (e.g. media publisher manager 102) are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. Aspects of the invention described herein includes these and other various types of computer-readable storage media when such media contain instructions or programs for implementing the steps described below in conjunction with a microprocessor or other data processor. Further, aspects of the invention include the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer (e.g. media publisher manager 102), embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Generally, program modules include, but are not limited to, routines, programs, objects, components, and data structures that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

In operation, computer (e.g. media publisher manager 102) executes computer-executable instructions such as those illustrated in the figures to implement aspects of the invention.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

Embodiments of the invention may be implemented with computer-executable instructions. The computer-executable instructions may be organized into one or more computer-executable components or modules. Aspects of the invention may be implemented with any number and organization of such components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

### Appendix A

Appendix A contains an exemplary public API according to aspects of the invention.

### Error Codes

We will be defining new HRESULT based error codes. The new codes we will be using will be based on the MAKE_HRESULT facility. Here is the list of codes we will be creating:

```
// defines for making new error codes
#define MEIDA_PUBSUB_ERR_BASE 0x2000
#define MAKE_MEDIA_PUBSUB_HR(sev,code)
MAKE_HRESULT(sev,
FACILITY_ITF,(MEDIA_PUBSUB_ERR_BASE + code))
#define MAKE_MEDIA_PUBSUB_HR_ERR(code)
MAKE_MEDIA_PUBSUB_ERR_HR(1,code)
// new error codes for PUBSUB
#define MEDIA_PUBSUB_ERR_NOUSERLOGGEDIN
    MAKE_PUBSUB_HR_ERR(0xf02)
#define MEDIA_PUBSUB_ERR_UNEXPECTEDMONIKERTYPE
    MAKE_PUBSUB_HR_ERR(0xf03)
#define MEDIA_PUBSUB_ERR_INVALIDMONIKER
    MAKE_PUBSUB_HR_ERR(0xf04)
•
Structures/Enums/Defines
MediaPublishSubscribeMonikerType enum
typedef enum
{
```

| | |
|---|---|
| MPSMT_Provider | = 1, |
| MPSMT_Site | = 2, |
| MPSMT_User | = 3, |
| MPSMT_Container | = 4, |
| MPSMT_Item | = 5 |

} MediaPublishSubscribeMonikerType;
MediaPublishSubscribeSiteType enum
typedef enum
{

| | |
|---|---|
| MPSST_PersonalSite | = 1, |
| MPSST_EventSite | = 2 |

} MediaPublishSubscribeSiteType;
MediaPublishSubscribeBitmapType enum
typedef enum
{

| | |
|---|---|
| MPSSBT_Thumbnail | = 1, |
| MPSSBT_LargestAvailable | = 2 |

} MediaPublishSubscribeBitmapType;
MediaPublishSubscribeMoniker struct
typedef struct
{

| | |
|---|---|
| DWORD | dwSize; |
| GUID | ProviderID; |
| MediaPublishSubscribeMonikerType | MonikerType; |
| BYTE | Data[1]; |
| } MediaPublishSubscribeMoniker; | |

Whenever moniker ownership is handed from one component to another component, the assumption is that the moniker memory was allocated using CoTaskMcmAlloc and should be freed using CoTaskMemFree. Additionally, the dwSize member records the entire size of the moniker allocation, not just the size of the Data[ ] field.

| MediaPublishSubscribeMonikerCapabilities struct | |
|---|---|
| typedef struct | |
| { | |
| MediaPublishSubscribeMonikerType | Type; |
| UINT | Capabilities; |

} MediaPublishSubscribeMonikerCapabilities;

Capabilities is to be treated as a bitmask, and we will define appropriate capability #define's to express what is allowed. Things like “can add items, can create containers, etc.” If we think that there are not likely to be more than 32 (or 64) different capability identifiers in total, than we can remove the union and likely the type and just use a 32 or 64 bit UINT.

| MediaPublishSubscribeCreateSiteInfo struct | |
|---|---|
| typedef struct | |
| { | |
| LPCWSTR | pName; |
| MediaPublishSubscribeSiteType | Type; |
| HBITMAP | hThumbnail; |

| } MediaPublishSubscribeCreateSiteInfo; | |
|---|---|
| MediaPublishSubscribeCreateContainerInfo struct | |
| typedef struct | |
| { | |
| LPCWSTR | pName; |
| HBITMAP | hThumbnail; |
| } MediaPublishSubscribeCreateContainerInfo; | |
| MediaPublishSubscribeCreateItemInfo struct | |
| typedef struct | |
| { | |
| LPCWSTR | pItemName; |
| BOOL | fCreateAlways; |
| LPCWSTR | pSourceFileName; |
| HBITMAP | hThumbnail; |

} MediaPublishSubscribeCreateItemInfo;

If MediaPublishSubscribeCreateItemInfo.hThumbnail is NULL, then a thumbnail will be generated automatically. Otherwise, the supplied HBITMAP will be used for the thumbnail. For photos, the expectation is that the thumbnail will likely be automatically generated. For videos, the expectation is that the thumbnail will likely be passed in.

If MediaPublishSubscribeCreateItemInfo.fCreateAlways is true, then if the item already exists on the provider then it will be replaced with the contents of MediaPublishSubscribeCreateItemInfo.pSourceFileName.

If MediaPublishSubscribeCreateItemInfo.fCreateAlways is false, and the item already exists on the provider, then this method will return an error and the item that already exists on the provider will not be modified.

```
MediaPublishSubscribeQuotaInfo struct
typedef struct
{
    MediaPublishSubscribeQuotaType quotaType;
    UINT  uMax;
    UINT
    uCurrentlyUsed;
} MediaPublishSubscribeQuotaInfo;
MediaPublishSubscribeQuotaType enum
typedef enum
{
    MPSQT_Megabytes = 0,
    MPSQT_Items = 1,
    MPSQT_MegabytesPerMonth = 2,
    MPSQT_ItemsPerMonth = 3
} MediaPublishSubscribeQuotaType;
```

### IMediaPublishSubscribeProvider COM Interface.

IMediaPublishSubscribeProvider is a COM interface that web properties implement so that they can plug into the dataflow publish & subscribe layer. It is an abstraction around the functionality we need each web provider to supply. There can be multiple IMediaPublishSubscribeProvider's registered, but usually only one IMediaPublishSubscribeProvider per web property, and only once instance of a web property's IMediaPublishSubscribeProvider active at a given time.

typedef interface IMediaPublishSubscribeProvider: public
IUnknown
{
HRESULT Initialize(in HWND hwnd);

Called to initialize the provider. The HWND can be passed in as a parent window to launch provider-specific UI (e.g. the signin dialog)

```
  HRESULT GetContainedItemsEnumerator(
          in MediaPublishSubscribeMoniker*
pContainer,
          out
  IEnumMediaPublishSubscribeMonikers** ppEnum
          );
```

Called to return the contents of a site or container moniker. For a site moniker, you will usually get back containers. For container monikers, you can get back both container & item monikers in the enumerator. IEnumMediaPublishSubscribeMonikers is based on a standard COM enumerator, and *ppEnum contains a reference that the caller must release.

```
  HRESULT GetMonikerURI(
          in MediaPublishSubscribeMoniker*
pMoniker,
          out BSTR* ppURI
          );
```

Return the URI for the moniker. This is assumed to be a fast call that only cracks the moniker data, and does not hit the cloud to get the information.

```
HRESULT GetMonikerAttributes(
          in
MediaPublishSubscribeMoniker* pMoniker,
          in_out
IMediaPublishSubscribeMonikerAttributes** ppAttrib
          );
```

Used to return attribute interface for a given moniker object—user, site, provider, container, item. This call is not assumed to be fast—it can hit the cloud to get information that is not already cached in the provider. The interface pointed to by *ppAttrib will have one COM reference on the object and that reference must be freed by the caller.

```
HRESULT GetMonikerCapabilities(
          in
MediaPublishSubscribeMoniker* pMoniker,
          in_out
MediaPublishSubscribeMonikerCapabilties* pCapabilities
          )
```

Given a moniker, return the current capabilities associated with that site/container/item. The capabilities are returned via the MediaPublishSubscribeMonikerCapabilites struct.

```
HRESULT GetMonikerThumbnail(
          in MediaPublishSubscribeMoniker*
pMoniker,
          out HBITMAP* phbmThumb
          );
```

Given a moniker, returns the associated thumbnail/art. The thumbnail is returned as a HBITMAP, and must be freed by the caller.

```
  HRESULT GetDefaultContainedItem(
          in
  MediaPublishSubscribeMoniker* pMoniker,
          in_out MediaPublishSubscribeMoniker**
ppDefaultItemMoniker
          );
```

Returns the moniker for the child item that is the default item for this container. This is how, for instance, we will get the “thumbnail” for an album-we'll use the thumbnail of the default item. The memory backing the *ppDefaultItemMoniker is allocated using CoTaskMemAlloc and must be freed using CoTaskMemFree.

```
HRESULT GetQuota(
          in
MediaPublishSubscribeMoniker* pContainer,
          in_out
MediaPublishSubscribeQuotaInfo* pQuota
          );
```

Gets the quota associated with the container specified by pContainer.

```
  HRESULT SignIn(
          in HWND hwnd,
          <optional> in
MediaPublishSubscribeMoniker* pUserMoniker
          );
```

Requests that the provider initiate a user sign in. pUserMoniker is an optional parameter to specify which user account to sign in under. If it is NULL, a default sign-in should happen (eg: put up sign-in UI). If another user is already signed in, this method returns S_FALSE.

HRESULT SignOut( );

Signs out the currently logged in user.

```
  HRESULT GetCurrentUser(
          out MediaPublishSubscribeMoniker**
ppCurrentUserMoniker
          );
```

Returns a moniker for the currently signed-in user. The memory backing the **ppCurrentUserMoniker is allocated using CoTaskMemAlloc and must be freed using CoTaskMemFree.

```
  HRESULT CreateMonikerFromURL(
          in LPWSTR pURL,
          out MediaPublishSubscribeMoniker**
ppCurrentUserMoniker
          );
```

Given an URL that is scoped to the provider's web property, return a moniker that represents the object the URL pointed to. For instance, if the passed in URL is to an album on a Spaces site, and this is the Spaces provider, return a container moniker. The backing memory for the moniker is allocated using CoTaskMemAlloc and must be freed using CoTaskMemFree.

```
HRESULT CreateSite(
          in
MediaPublishSubscribeCreateSiteInfo* pCreateParams
          );
```

Creates a new site for the currently logged in user.

```
HRESULT CreateContainer(
          in
MediaPublishSubscribeCreateContainerInfo* pCreateParams
          );
```

Creates a new container for the currently logged in user within the parent object specified. For example, this would create a new photo album in the chosen space.

```
  HRESULT CreateItem(
          MediaPublishSubscribeCreateItemInfo*
pCreateParams
          );
```

Creates a new item for the currently logged in user within the parent object specified and transfers the file specified to the site. For example, this would create a new Media Asset (photo/video/audio, etc.) within an album on a space.

HRESULT AddSubscription (in MediaPublishSubscribeMoniker*
pFeed);

Adds a subscription for the currently logged in user to the object specified. The object can be a user, site, or container. For example, this would add a subscription to another user's space and involve writing a new address book entry for the current user in ABCH.

HRESULT RemoveSubscription(in
MediaPublishSubscribeMoniker* pFeed);

Removes a subscription for the currently logged in user to the object specified. The object can be a user, site, or container. For example, this would remove a subscription to another user's space and involve editing an address book entry for the current user in ABCH.

```
    HRESULT GetUserMonikerForCid(
                    in  LPWSTR pszCid,
                    in_out MediaPublishSubscribeMoniker*
pUser
                    ;
```

Given a CID, constructs a user moniker that can be used with the rest of the publish/subscribe API.

```
    HRESULT GetCidForUserMoniker(
                    in  MediaPublishSubscribeMoniker*
pUser,
                    in_out  LPWSTR pszCid
                    );
```

Given a user moniker, crack the moniker and return the public identity (CID) to be able to log into ABCH and get contact lists.

```
HRESULT GetSubscriptionsEnumerator(
                    out
    IEnumMediaPublishSubscribeMonikers** ppEnum
                    );
```

Called to return the list of subscriptions for the current user. This will typically return a list of sites (for photo feeds) and/or albums (for favorites). IEnumMediaPublishSubscribeMonikers is based on a standard COM enumerator, and *ppEnum contains a reference that the caller must release.

}; // end of IMediaPublishSubscribeProvider

### IMediaPublishSubscribeProviderManager COM Interface.

IPublishSubscribeProviderManager is an aggregator of IMediaPublishSubscribeProvider's. It allows clients to interact via an abstraction that allows them to use the same programming model independent of what actual web property they are talking to.

The IMediaPublishSubscribeProviderManager is a singleton COM object. We will use ATL's infrastructure to enforce the singleton nature. A byproduct of doing it this way is that once an IMediaPublishSubscribeProviderManager is created, it will remain active for the lifetime of the module, even if all explicit references to the object are free'd.

typedef interface IMediaPublishSubscribeProviderManager :
public IUnknown
{
HRESULT Initialize( );

Causes the manager object to initialize itself by looking for and initializing registered providers. Providers will be listed in a registry location. The registry location is TBD.

HRESULT AddListener(in HWND hwnd);

The specified HWND will get notification messages posted to it. The actual notifications will be documented in a different section of this doc. We are not providing an ability to selectively register for particular notifications. You either get all or none.

HRESULT RemoveListener(in HWND hwnd);

The specified HWND will no longer receive notification messages. It is only necessary to call this method if you want to stop receiving notifications prior to the end of the lifetime of the IPubSubProviderManager object. (eg: you can be courteous and inform us not to try to send notifications, but the object is resilient in terms of failure to send messages).

```
    HRESULT GetProvidersEnumerator(
                    out
IEnumMediaPublishSubscribeMonikers** ppEnum
                    );
```

Returns a standard COM enumerator for providers. IEnumMediaPublishSubscribeMonikers is based on a standard COM enumerator, and *ppEnum contains a reference that the caller must release. *ppEnum will return provider PSMKRs for each registered provider. These PSMKRs can then be passed to IPubSubProviderManager::GetMonikerAttributes( . . . ) to get things like friendly name, icon, etc., for each provider.

```
HRESULT GetContainedItemsEnumerator(
                    in  MediaPublishSubscribeMoniker*
pParent,
                    out
        IEnumMediaPublishSubscribeMonikers** ppEnum
                    );
```

Delegates to the appropriate provider based on the ProviderId of the specified moniker. Returns a standard COM enumerator for child items of the parent. IEnumMediaPublishSubscribeMonikers is based on a standard COM enumerator, and *ppEnum contains a reference that the caller must release. For instance, if pParent points to a moniker for a site, then the enumerator would return monikers for the containers (i.e. albums) that this site contains.

```
    HRESULT GetMonikerAttributes(
                    in MediaPublishSubscribeMoniker*
pMoniker,
                    out
    IMediaPublishSubscribeMonikerAttributes** ppAttrib
                    );
```

Delegates to the appropriate provider based on the ProviderId of the specified moniker. Used to return attribute interface for a given moniker object—user, site, provider, container, item. This call is not assumed to be fast—it can hit the cloud to get information that is not already cached in the provider. The interface pointed to by *ppAttrib will have one COM reference on the object and that reference must be freed by the caller.

```
    HRESULT GetMonikerCapabilities(
                    in  MediaPublishSubscribeMoniker*
pPMKR,
                    out
    MediaPublishSubscribeMonikerCapabilites* pCapabilities
                    );
```

Delegates to the appropriate provider based on the ProviderId of the specified moniker. Given a moniker, return the current capabilities associated with that site/container/item. The capabilities are returned via the MediaPublishSubscribeMonikerCapabilites struct.

```
    HRESULT GetMonikerThumbnail(
                    in MediaPublishSubscribeMoniker*
pMoniker,
                    out HBITMAP* phbmThumb
                    );
```

Delegates to the appropriate provider based on the ProviderId of the specified moniker. Given a moniker, returns the associated thumbnail/art. The thumbnail is returned as a HBITMAP, and must be freed by the caller.

```
HRESULT GetQuota(
                    in
    MediaPublishSubscribeMoniker* pContainer,
                    in_out
    MediaPublishSubscribeQuotaInfo* pQuota
                    );
```

Delegates to the appropriate provider based on the ProviderId of the specified moniker. Gets the quota associated with the container specified by pContainer.

```
    HRESULT SignIn(
                    in  REFGUID Provider,
                    <optional> in
MediaPublishSubscribeMoniker* pUserMoniker
                    );
```

Delegates to the appropriate provider based on the specified provider GUID. This call will initiate the sign in process for the specified provider. The caller must be registered to receive notifications to get informed of subsequent sign in events (status, completion, user PMKR for the signed in user). HRESULT SignOut (in REFGUID Provider);

Delegates to the appropriate provider based on the specified provider GUID. Signs out the currently logged in user.

```
HRESULT GetCurrentUser(
                    in  REFGUID Provider,
                    out MediaPublishSubscribeMoniker**
ppCurrentUserMoniker
                    );
```

Delegates to the appropriate provider based on the specified provider GUID. Returns a moniker for the currently signed-in user. The memory backing the **ppCurrentUserMoniker is allocated using CoTaskMemAlloc and must be freed using CoTaskMemFree.

```
    HRESULT CreateMonikerFromURL(
                    in REFGUID Provider,
                    in LPWSTR pURL,
                    out MediaPublishSubscribeMoniker**
ppCurrentUserMoniker
                    );
```

Delegates to the appropriate provider based on the specified provider GUID. Given an URL and a GUID for the provider that the URL is scoped to, return a moniker that represents the object the URL pointed to. The backing memory for the moniker is allocated using CoTaskMemAlloc and must be freed using CoTaskMemFree.

```
HRESULT CreateSite(
                    in  REFGUID Provider,
                    in
MeidaPublishSubscribeCreateSiteInfo* pCreateParams
                    );
```

Delegated to the appropriate provider based on the specified provider GUID. Given the GUID of the desired provider, create a new site with the options & attributes specified in the PubSubCreateSiteInfo.

```
    HRESULT CreateContainer(
                        in  MediaPublishSubscribeMoniker*
pParent,
                        in
    MediaPublishSubscribeCreateContainerInfo* pCreateParams
                        );
```

Delegates to the appropriate provider based on the ProviderId of the specified moniker. Given the moniker of a parent (site or container), create a new container (ie: album) in that parent. Once created, set the options & attributes specified in the PubSubCreateContainerInfo struct.

```
    HRESULT CreateItem(
                        In  MediaPublishSubscribeMoniker*
pContainer,
                        In
    MediaPublishSubscribeCreateItemInfo* pCreateParams
                        );
```

Delegates to the appropriate provider based on the ProviderId of the specified moniker. Given the moniker of a container, create a new item (photo/video/etc) in that container. Once created, set the options & attributes specified in the PubSubCreateItemInfo struct.

Calling IPubSubManager::CreateItem( ) will upload the file in question to the server. This is a synchronous call. It will fire notifications to any listeners, however.

HRESULT AddSubscription(in MediaPublishSubscribeMoniker*
pFeed);

Delegates to the appropriate provider based on the ProviderId of the specified moniker. Adds a subscription for the currently logged in user to the object specified. The object can be a user, site, or container.

HRESULT RemoveSubscription(in
MediaPublishSubscribeMoniker* pFeed);

Delegates to the appropriate provider based on the ProviderId of the specified moniker. Removes a subscription for the currently logged in user to the object specified. The object can be a user, site, or container.

```
    HRESULT GetUserMonikerForCid(
              in  LPWSTR pszCid,
              in_out MediaPublishSubscribeMoniker*
pUser
              );
```

Constructs a user moniker that can be used with the rest of the publish/subscribe API.

```
    HRESULT GetCidForUserMoniker(
                        in  MediaPublishSubscribeMoniker*
pUser,
                        in_out  LPWSTR pszCid
                        );
```

Given a user moniker, crack the moniker and return the public identity (CID) to be able to log into ABCH and get contact lists.

```
HRESULT GetSubscriptionsEnumerator(
                        in REFGUID Provider,
                        out
    IEnumMediaPublishSubscribeMonikers** ppEnum
                        );
```

Delegates to the appropriate provider based on the specified provider GUID. Called to return the list of subscriptions for the current user. This will typically return a list of sites (for photo feeds) and/or albums (for favorites). IEnumMediaPublishSubscribeMonikers is based on a standard COM enumerator, and *ppEnum contains a reference that the caller must release.

}; // end of IMediaPublishSubscribeProviderManager

### IMediaPublishSubscribeMonikerAttrbiutes COM Interface

This COM interface is a “base” interface for all of the other moniker attribute interfaces and provides facilities for returning common information for all monikers.

```
typedef interface IMediaPublishSubscribeMonikerAttributes :
IUnknown
{
    HRESULT GetType(
        [out] MediaPublishSubscribeMonikerType* pMonikerType
        );
```

Returns the type of the moniker.

```
HRESULT GetProvider(
    [out] GUID* pGUID
    );
```

Returns a GUID that represents the provider that this moniker was created by.

```
HRESULT GetName(
    [out] BSTR* pName
    );
```

Returns the friendly name for the object the moniker represents.

```
HRESULT GetURI(
    [out] BSTR* pURI
    );
```

Returns the URI for the object the moniker represents.

```
HRESULT GetCreationTime(
    [out] FILETIME* pCreationTime
    );
```

Returns the UTC based creation time of the object the moniker represents.

```
HRESULT GetLastModifiedTime(
    [out] FILETIME* pLastModifiedTime
    );
```

Returns the UTC based last modified time of object the moniker represents.

```
HRESULT GetContainedItemsCount(
    [out] UINT* pCount
    );
```

Returns the number of child items for this object. This is a 1-level deep scan, it is not a fully hierarchical scan (i.e.: it only returns the count of the first level of children under this node). This call is only valid for Site & Container monikers. It will fail with MEDIA_PUBSUB_ERR_UNEXPECTEDMONIKERTYPE for other moniker types.

}; // end of IMediaPublishSubscribeMonikerAttributes

### IMediaPublishSubscribeUserMonikerAttributes COM Interface

This COM interface is used to get attribute information about User monikers.

```
typedef interface IMediaPublishSubscribeUserMonikerAttributes
:
    IMediaPublishSubscribeMonikerAttributes
{
    HRESULT GetFirstName(
        [out] BSTR* pFirstName
        );
```

Returns the first name of the user.

```
HRESULT GetLastName(
    [out] BSTR* pLastName
    );
```

Returns the last name of the user.

}; // end of IMediaPublishSubscribeUserMonikerAttibutes

### Publish & Subscribe Helper API

The publish and subscribe helper API will be encapsulated in a ref-counted object called MediaPublishSubscribeHelper. The MediaPublishSubscribeHelper will have the following methods:

```
class MediaPublishSubscribeHelper
{
public:
    void GetMediaPublishSubscribeProviderManager(
                out
    IMediaPublishSubscribeProviderManager** ppManager
                );
```

Returns a pointer to the currently in use IMediaPublishSubscribeProviderManager COM object. Calling this method will add a reference via IUnknown::AddRef( ) to the COM object, so callers must free that reference via IUnknown::Release( ) once they are done with the returned COM object. void SyncSubscriptions( );

Calling this method will cause work items to get scheduled in the pub/sub grinder task to update all subscription information in the database. This will entail going out to the cloud to make sure that all site/album/item information is up to date. All calls are made against the currently logged in user. If no user is currently logged in, this call will fall. Callers of this method can track results via DB & IMediaPublishSubscribeProviderManager notifications.

void SyncPublishInfo( );

Calling this method will cause work items to get scheduled in the pub/sub grinder task to update the list of “publishable” places (sites/containers) that are available for the currently logged in user. If there is no currently logged in user, this call will return a failure and no work items will get scheduled. Callers of this method can track results via DB notifications.

```
  void CreateContainerAndPublishItems(
          in  MediaPublishSubscribeMoniker*
pSite,
          in
  MediaPublishSubscibeCreateContainerInfo* pCreateParams,
          in  IObjectIDSet*  pSourceItems
          );
```

Calling this method will cause work items to get scheduled in the pub/sub grinder task to first create a new container, then add each of the items identified in the pSourceItems set. The caller can track progress by listening to DB notifications.

```
  void PublishItems(
                in  MediaPublishSubscribeMoniker*
pContainer,
                in  IObjectIDSet* pSourceItems
                );
```

Calling this method will cause work items to get scheduled in the pub/sub grinder task to add each of the items identified in the pSourceItems set to the container specified in *pContainer. The caller can track progress by listening to DB notifications.

```
  void AddSubscription(
                  in  MediaPublishSubscribeMoniker*
pUser,
                  in  MediaPublishSubscribeMoniker*
pSubscribedItem
                  );
```

Calling this method will write information in the database to reflect the new subscription. pSubscribedItem is usually a site. The only time this is not true is if you are subscribing to a “Favorite”—in this case, pSubscribedItem would be a container.

```
    void RemoveSubscription(
              in  MediaPublishSubscribeMoniker*
pUser,
              in  MediaPublishSubscribeMoniker*
pSubscribedItem
          );
```

Calling this method removes information in the database about the specified subscription.

}; // end of MediaPublishSubscribeHelper

What is claimed is:

1. A method for publishing media objects to a provider, comprising:
identifying a plurality of plug-ins, one corresponding to each of a plurality of the providers, each of the providers hosting a web space including a media object, each of the providers implementing a plurality of services related to the media object, wherein executing the corresponding plug-in for a particular provider causes at least one of the plurality of services of the particular provider related to the media object to be performed on the particular provider;
receiving a request from a client, said request including a function related to a media object;
selecting one of the plurality of plug-ins to execute based on the included function;
executing the selected plug-in, wherein executing the selected plug-in causes a service related to the media object to be performed on the provider, said service related to the requested function;
receiving a status from the provider, said status indicating the success of the performed service; and
sending the status from the provider to the client, said status indicating the success of the request.

2. The method of claim 1, wherein the requested function includes the uploading of the media object to the provider, and further comprising:
selecting one of the plurality of plug-ins to execute to upload the media object;
executing the selected plug-in, wherein executing the selected plug-in causes the provider to upload the media object from the client;
receiving a moniker for the uploaded media object from the provider in response to the execution of the plug-in, said moniker being generated by the provider in response to the uploading of the media object, said moniker including the uploaded media object identifier and a provider identifier, said provider identifier associated with the at least one of the providers which uploaded the media object, said media object identifier representing the uploaded media object in the abstract namespace of the provider; and
sending the moniker to the client wherein the client references the uploaded media object via the moniker.

3. The method of claim 2, wherein the moniker is in a serialized form.

4. The method of claim 1, wherein the request includes a moniker of the media object, said moniker generated from a media object identifier and a provider identifier, said moniker being provided a first provider, said first provider hosting the media object associated with the media identifier, said provider identifier associated with the at least one of the providers, further comprising:
determining the provider identifier from the moniker included in the request;
selecting a plug-in to execute from the generated plug-ins based on the included function and the provider identifier;
executing the selected plug-in, wherein executing the selected plug-in causes a service related to the media object to be performed on the provider, said service related to the requested function and the determined media object identifier;
receiving a status from the provider, said status indicating the success of the performed service; and
sending the status from the provider to the client, said status indicating the success of the request.

5. The method of claim 4, wherein the moniker is in a serialized form.

6. The method of claim 1, wherein the media object includes one or more of the following: a digital photograph, a digital video, a digital sound recording, and a document.

7. The method of claim 1, wherein the function includes one or more of the following: Publish a media object to a provider; remove a media object from a provider, download a media object from a provider, subscribe to a media object of a provider, list the media objects published, list the providers that have invited the client to subscribe, and list the media objects subscribed.

8. The method of claim 1, wherein status is received asynchronously from the provider.

9. The method of claim 1, wherein media objects are related to social networking.

10. The method of claim 1, wherein the plug-in utilizes one or more of the following protocols to communicate with provider: SOAP, RSS, HTTP, telnet.

11. A method for publishing media objects to a provider, comprising:
generating a plug-in for each of a plurality of providers, each provider hosting a web space including a media object, each provider implementing a plurality of services related to the media object, wherein executing the plug-in causes at least one of the plurality of services related to the media object to be performed on at least one of plurality of providers;
receiving a request from a client, said request including a function related to a media object, said request including a moniker of the media object, said moniker generated from a media object identifier and a provider identifier, said moniker being provided a first provider, said first provider hosting the media object associated with the media identifier, said provider identifier associated with the at least one of the providers;
determining the provider identifier from the moniker included in the request;
selecting a plug-in to execute from the generated plug-ins based on the included function and the provider identifier;
executing the selected plug-in, wherein executing the selected plug-in causes a service related to the media object to be performed on the provider, said service related to the requested function;
receiving a status from the provider, said status indicating the success of the performed service; and
sending the status from the provider to the client, said status indicating the success of the request.

12. The method of claim 11, wherein the requested function includes the downloading of the media object to the provider, further comprising:
selecting a plug-in to execute from the generated plug-ins to download the media object from the provider associated with the determined provider identifier; and
executing the selected plug-in, wherein executing the selected plug-in causes the provider to download the media object to the client.

13. The method of claim 11, wherein the moniker is in a serialized form.

14. The method of claim 11, wherein the media object includes one or more of the following: a digital photograph, a digital video, a digital sound recording, and a document.

15. The method of claim 11, wherein the function includes one or more of the following: Publish a media object to a provider; remove a media object from a provider, download a media object from a provider, subscribe to a media object of a provider, list the media objects published, list the providers that have invited the client to subscribe, and list the media objects subscribed.

16. The method of claim 11, wherein status is received asynchronously from the provider.

17. The method of claim 11, wherein media objects are related to social networking.

18. The method of claim 11, wherein the plug-in utilizes one or more of the following protocols to communicate with provider: SOAP, RSS, HTTP, telnet.

19. A application program interface (API) for publishing media objects to a provider, comprising computer readable instructions for:
generating a plug-in for each of a plurality of providers, each provider hosting a web space including a media object, each provider implementing a plurality of services related to the media object, wherein executing the plug-in causes at least one of the plurality of services related to the media object to be performed on at least one of plurality of providers;
receiving a first request from a client, said first request including the uploading of a media object;
selecting a plug-in to execute from the generated plug-ins to upload the media object;
executing the selected plug-in, wherein executing the selected plug-in causes the provider to upload the media object from the client;
receiving a moniker for the uploaded media object from the provider in response to the execution of the plug-in, said moniker being generated by the provider in response to the uploading of the media object, said moniker including the uploaded media object identifier and a provider identifier, said provider identifier associated with the at least one of the providers which uploaded the media object; and
sending the moniker to the client wherein the client references the uploaded media object via the moniker
receiving a status from the provider, said status indicating the success of the performed service; and
sending the status from the provider to the client, said status indicating the success of the first request.
receiving a second request including a function related to the media object and the moniker of the media object;
determining the provider identifier from the moniker included in the second request;
selecting a plug-in to execute from the generated plug-ins based on the included function and the provider identifier;
executing the selected plug-in, wherein executing the selected plug-in causes a service related to the media object to be performed on the provider, said service related to the requested function and the determined media object identifier;
receiving a status from the provider, said status indicating the success of the performed service; and
sending the status from the provider to the client, said status indicating the success of the second request.

20. The API of claim 19, wherein the plug-in utilizes one or more of the following protocols to communicate with provider: SOAP, RSS, HTTP, telnet.
